(19) United States
(12) Patent Application Publication
(10) Pub. No.: US 2006/0165469 A1
(43) Pub. Date: Jul. 27, 2006

(54) Printer and printing method

(75) Inventor: Masatoshi Oku, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/336,786

(22) Filed: Jan. 23, 2006

(30) Foreign Application Priority Data
Jan. 21, 2005 (JP) 2005-014733

(51) Int. Cl. B41J 11/24

(52) U.S. Cl. 400/641; 400/636

(57) ABSTRACT

An image is recorded on a recording material line by line during transport of the recording material by a drive roller and a driven roller. Rotation of a motor is transmitted to the drive roller via a traction drive decelerating mechanism. An output shaft of the traction drive decelerating mechanism and a first end of the drive roller are connected on the common axis with a connector. A second end of the drive roller and the traction drive decelerating mechanism are cantilever-supported by a drive roller supporting mechanism.

### FIELD OF THE INVENTION

The present invention relates to a printer and a printing method for recording an image on a recording material nipped and transported by a transport roller pair consisting of a drive roller and a driven roller.

### BACKGROUND OF THE INVENTION

A direct thermal printer including a thermal head which thermally records an image by developing colors onto a thermosensitive recording sheet provided with thermosensitive coloring layers, is known. The thermal head has a heating element array on which a number of heating elements are aligned in a main scan direction. The heating element array is heated at predetermined temperature based on one-line image data when the thermosensitive recording sheet is transported in a sub scan direction by a transport roller pair. The image is sequentially printed line by line during transport of the theremosensitive recording sheet by the transport roller pair, and an image print of one frame can be obtained.

The transport roller pair consists of a capstan roller and a nip roller which function as a drive roller and a driven roller respectively. The capstan roller is connected to a transport motor via a decelerating mechanism including a gear train, a timing belt and a timing pulley, and is rotated at low speed and with high precision.

However, each gear of the gear train may have a defect in shape of the teeth or a machining error such as decentering. Moreover, the timing pulley may also have a machining error such as decentering. When the capstan roller is rotated via such a decelerating mechanism, there occurs uneven rotation of the capstan roller due to periodical vibration and fluctuation in the rotational speed of the capstan roller. When the uneven rotation occurs, transport speed of the thermosensitive recording sheet periodically fluctuates, thereby the transport amount of the thermosensitive recording sheet periodically changes. As a result, it is likely to occur periodical uneven shading on the image print, so called uneven printing density.

Japanese Patent Laid-Open Publication No. 09-230662 discloses a printer using a traction drive decelerating mechanism which eliminates the use of the gear or the timing belt, as the decelerating mechanism. Uneven rotation of the capstan roller is caused if the output shaft (drive shaft) of the traction drive decelerating mechanism would be connected off axis to the rotary shaft of the capstan roller, and the rotation of the transport motor is transmitted to the capstan roller via the traction drive decelerating mechanism. Consequently, the rotary shaft of the capstan roller and the output shaft of the traction drive decelerating mechanism are connected by a flexible coupling or an automatic alignment mechanism in order to correct such misplacement of the shafts and reduce the occurrence of uneven rotation of the capstan roller.

Usually, the capstan roller and the traction drive decelerating mechanism are separately mounted on the side plates inside the printer. In most cases, there occur mounting errors (assembling error) at the mounting positions of the capstan roller and the traction drive decelerating mechanism. Therefore, even when the rotary shaft of the capstan roller and the output shaft of the traction drive decelerating mechanism are connected by using the flexible coupling or the automatic alignment mechanism, it is impossible to prevent shaft misplacement completely. As a result, it is likely to occur uneven rotation of the capstan roller due to the shaft misplacement and, thereby, to occur uneven printing density on the image print.

### SUMMARY OF THE INVENTION

In view of the foregoing, an object of the present invention is to provide a printer and a printing method to obtain an image print without uneven printing density by restraining shaft misplacement of a rotary shaft of a capstan roller and an output shaft of a traction drive decelerating mechanism.

To achieve the above and other objects, in the present invention, a drive roller and a traction drive decelerating mechanism are respectively cantilever-supported by a drive roller supporting mechanism so that assembly of the drive roller and the traction drive decelerating mechanism is supported at two points. The drive roller includes a roller body and a rotary shaft, and the rotary shaft has first and second ends extending from the roller body. The traction drive decelerating mechanism has an output shaft for decelerating and outputting rotation of a motor. The output shaft and the first end of the drive roller are connected on the common axis with a connector.

A drive roller supporting mechanism is provided with a first bearing for enabling rotation of the second end and a second bearing for rotationally supporting the output shaft. Moreover, the drive roller supporting mechanism is provided with first and second side plates placed at both sides of the roller body, and a supporting member fixed to the second side plate. The first bearing is fit in the first side plate and an opening is formed in the second side plate for being inserted by the first end. The supporting member is fixed to the second side plate to cover the connector. The second bearing is fit in the supporting member and the traction drive decelerating mechanism is fixed outside the supporting member.

The traction drive decelerating mechanism is provided with a ring roller formed integral with the output shaft, an input shaft rotated by the motor, and a plurality of planetary rollers disposed about the input axis. The planetary rollers transmit rotation of the input shaft to the ring roller. The ring roller and the planetary rollers are housed in the case filled with grease.

A printing method of the present invention comprises steps: rotating a motor; transmitting rotation of the motor to a drive roller via a traction drive decelerating mechanism, a rotary shaft of said drive roller and an output shaft of the traction drive decelerating mechanism being connected on the same axis, the drive roller being rotatably supported at two points of one end of the rotary shaft of the drive roller and the traction drive decelerating mechanism; nipping the recording material between the drive roller and the driven roller to transport the recording material; and printing the image on the recording material during transport thereof line by line with a recording head.

According to the present invention, the first end of the rotary shaft of the drive roller and the output shaft of the traction drive decelerating mechanism are connected to have a common axis, and they are supported on the second end of the rotary shaft of the drive roller and on the traction drive decelerating mechanism. Therefore, there occurs no shaft misplacement and the occurrence of uneven rotation due to the shaft misplacement is prevented. As a result, the occurrence of uneven printing density on the image print can be prevented.

### BRIEF DESCRIPTION OF THE DRAWINGS

The above objects and advantages of the present invention will become apparent from the following detailed descriptions of the preferred embodiments of the invention when read in conjunction with the accompanying drawings, in which:

FIG. 1 is a schematic view showing a color direct thermal printer according to the present invention;

FIG. 2 is a sectional view showing a transport roller pair of the printer viewed from downstream side of a transport path;

FIG. 3 is a sectional view along a line III-III of FIG. 2, showing a traction drive decelerating mechanism for transmitting driving force of a motor to a capstan roller of a transport roller pair; and

FIG. 4 is a sectional view along a line IV-IV of FIG. 3.

### DESCRIPTION OF THE PREFERRED EMBODIMENTS

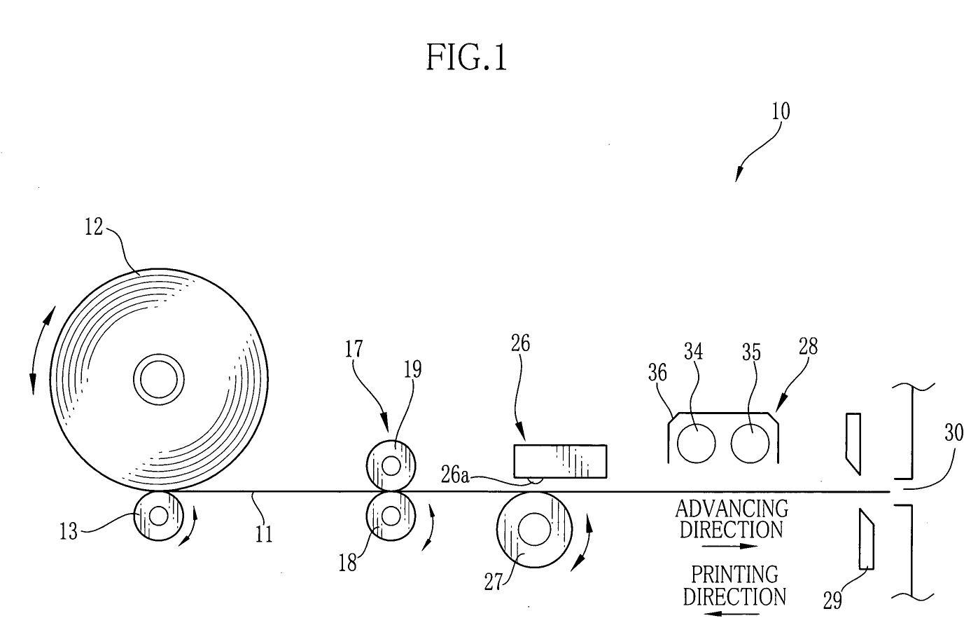

In FIG. 1, In a three-path type color direct thermal printer 10 (hereinafter referred to as a printer) made according to the present invention, a recoding sheet roll 12 formed by winding a long color thermosensitive recording sheet 11 (hereinafter referred to as recording sheet) into roll is used as a recording material. The recording sheet roll 12 is set in a sheet supply section of the printer 10, and an advancing roller 13 is pressed onto a peripheral surface of the recording sheet roll 12.

The advancing roller 13 is rotated and driven by a motor (not shown), and the recording sheet roll 12 is rotated to pull the recording sheet 11 and the recording sheet 11 is transported in the transport path from the sheet supply section. When printing is completed, the advancing roller 13 rewinds an unused portion of the recording sheet 11 back to the recording sheet roll 12 to keep it from influence of light and humidity.

It is known that the recording sheet 11 includes a cyan thermosensitive coloring layer, a magenta thermosensitive coloring layer and a yellow thermosensitive coloring layer, overlaid on a support in sequence. The yellow thermosensitive coloring layer, a topmost layer is most sensitive to heat among three thermal coloring layers, and is colored yellow with small printing heat energy. The cyan thermosensitive coloring layer, a lowermost layer is least sensitive to heat among three thermal coloring layers, and is colored cyan with large printing heat energy. The yellow thermosensitive coloring layer loses its coloring ability when near-ultraviolet rays at 420 nm is irradiated. The magenta thermosensitive coloring layer is colored with medium-heat energy between the yellow and cyan thermosensitive coloring layers and loses its coloring ability when ultraviolet rays at 365 nm are irradiated. The recording sheet 11 may include an extra coloring layer such as a black layer, in addition to the above yellow, magenta and cyan thermal coloring layers.

In the transporting path, a transport roller pair 17 is disposed for nipping and transporting the recording sheet 11. The transport roller pair 17 consists of a capstan roller 18 and a nip roller 19 functioning as a drive roller and a driven roller respectively and transports the recording sheet 11 in a sub scan direction perpendicular to a main scan direction, i.e. in an advancing direction and a printing direction.

In the downstream side of the transport roller pair 17 in the advancing direction, a thermal head 26, a platen roller 27, an optical fixing device 28, a cutter 29 and an discharge slot 30 are disposed in sequence from the upstream side along a transport path. The thermal head 26 and the platen roller 27 are disposed to sandwich the transport path of the recording sheet 11. The thermal head 26 is disposed above the transport path of the recording sheet 11 and is provided with a heat element array 26a on which a number of heating elements are aligned in a main scan direction. The thermal head 26 is moved by a head moving mechanism (not shown) between a pressing position to press the heat element array 26a to the recording sheet 11 and a retracted position to create a gap between the thermal head 26 and the platen roller 27. The platen roller 27 supports the recording sheet 11 and is rotated according to the move of the travelling recording sheet 11.

The heat element array 26a is heated on the basis of image data of one line when the recording sheet 11 is transported in the printing direction by the transport roller pair 17. As transported line by line by the transport roller pair 17, one thermosensitive coloring layer in the recording area of the recording sheet 11 is colored line by line.

The optical fixing device 28 is disposed to face the recording face of the recording sheet 11. The optical fixing device 28 includes a yellow fixing lamp 34, a magenta fixing lamp 35 and a reflector 36. The yellow fixing lamp 34 radiates near-ultraviolet rays having an emission peak at 420 nm to fix the yellow theremosensitive layer of the recording sheet 11. The magenta fixing lamp 35 radiates ultraviolet rays having the emission peak at 365 nm to fix the magenta theremosensitive layer.

The cutter 29 cuts the recording sheet 11 into a predetermined print size after completion of the three color image printing to provide a color print (not shown). The color print is discharged from the discharge slot 30.

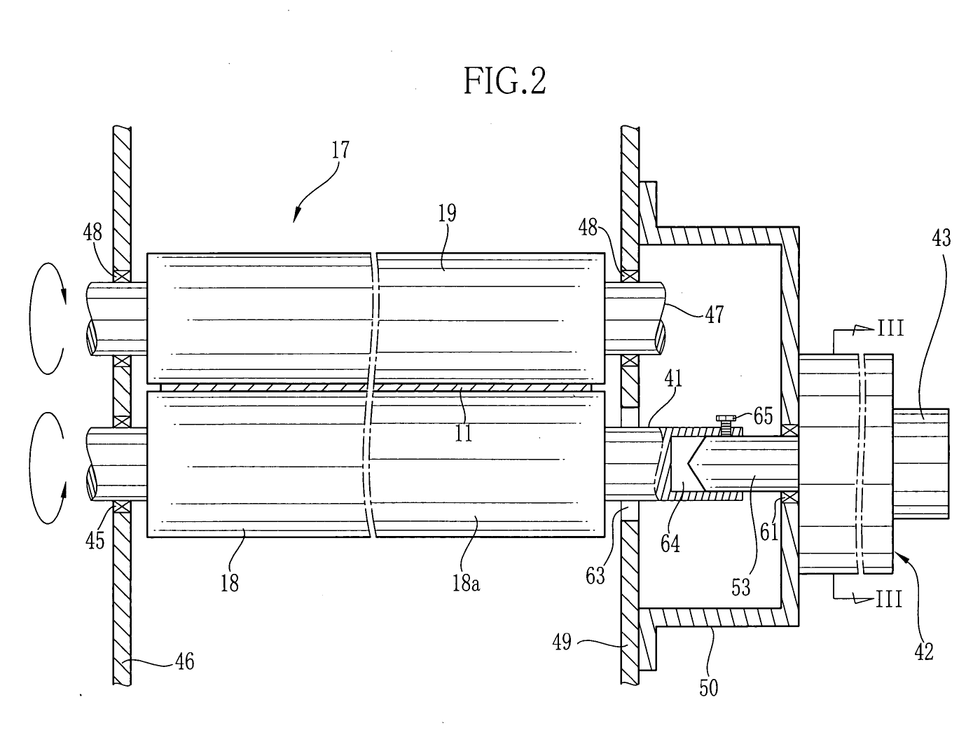

In FIG. 2, the capstan roller 18 has a roller body 18a and a rotary shaft 41 which is fixed to the roller body 18a in a manner that the roller body 18a is penetrated. One end of the rotary shaft 41 is connected to a transport motor 43 via a traction drive decelerating mechanism 42 and the other end of the rotary shaft 41 is supported by a side plate 46 functioning as a roller supporting member via a bearing 45 in a rotatable manner. The nip roller 19 has a rotary shaft 47. The both ends of the rotary shaft 47 are supported by the side plates 46, 49 in a rotatable manner via the bearings 48.

The traction drive decelerating mechanism 42 is fixed by a screw (not shown) or the like to a decelerating mechanism supporting member 50 attached on the side plate 49 and decelerates the rotation of the transport motor 43 to be transmitted to the rotary shaft 41 of the capstan roller 18. A stepping motor is used for the transport motor 43 and is fixed to the traction drive decelerating mechanism 42 by a screw (not shown) or the like. Transport amount of the recording sheet 11 is decided according to the number of drive pulse signals input to the transport motor 43, and the transport speed of the recording sheet 11 is decided according to frequency of each drive pulse signal.

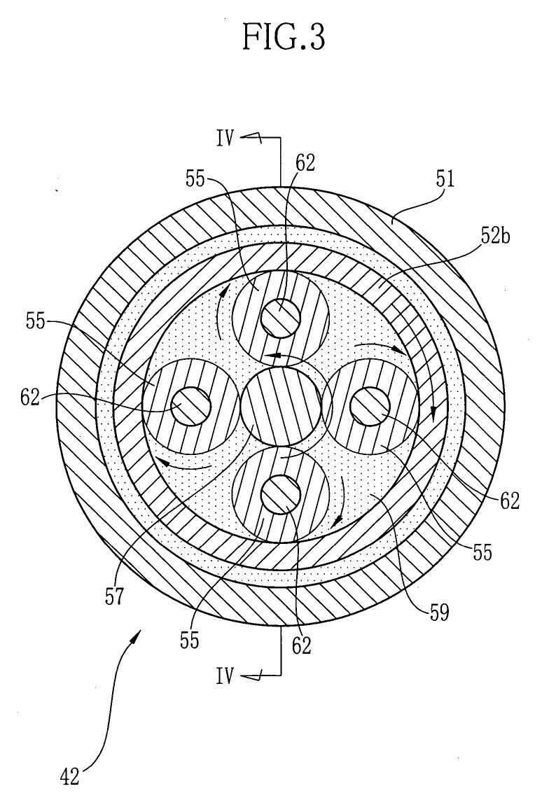

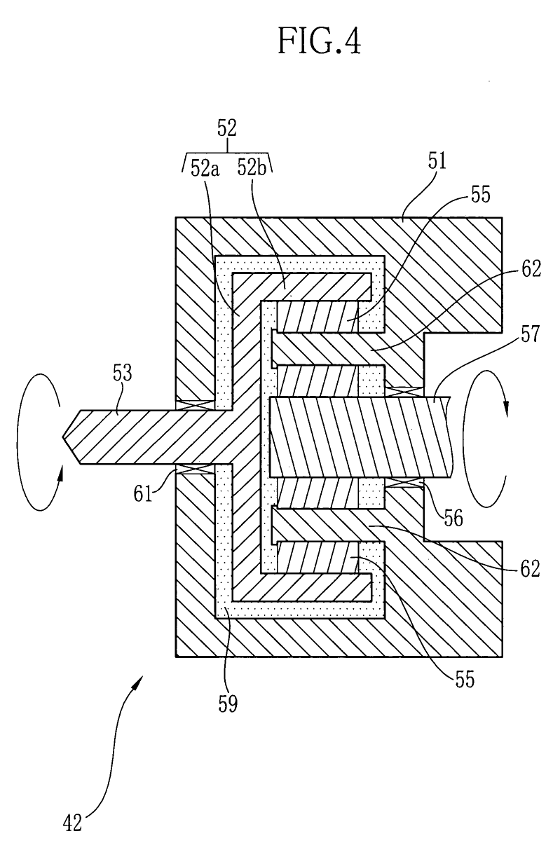

As shown in FIGS. 3 and 4, the traction drive decelerating mechanism 42 is provided with a case 51 with an approximate cylindrical shape and a ring roller 52 also with an approximately cylindrical shape provided inside the case 51. Moreover, the traction drive decelerating mechanism 42 includes an output shaft 53 connected to the rotary shaft 41 of the capstan roller 18, four planetary rollers 55 set inside the ring roller 52, an input shaft 57 supported by the case 51 in a rotatable manner via a bearing 56 and connected to the rotary shaft (not shown) of the transport motor 43, and traction grease 59 enclosed in the case 51. FIGS. 3 and 4 show one example of the traction drive decelerating mechanism, and the present invention is not intended to be limited to the above-described traction drive decelerating mechanism 42.

The ring roller 52 consists of a disk 52a and a cylinder 52b extending toward the transport motor 43 from the outer edge of the disk 52a. The above mentioned output shaft 53 is extended to the capstan roller 18 from the center of the disk 52a and is supported by the case 51 in a rotatable manner via a bearing 61.

The respective planetary rollers 55 are supported in a rotatable manner by roller shafts 62 fixed to the case 51 and are arranged at same intervals to encircle the input shaft 57, which is a sun roller. Diameter of the planetary rollers 55 is adjusted so that the respective planetary rollers 55 contact to the inner peripheral face of the ring roller 52 and the outer peripheral face of the input shaft 57. The planetary rollers 55 are mounted to the roller shafts 62 by the method, for example, so called “shrinkage fit”, in which the ring roller 52 is expanded under high temperature environment and, after the planetary rollers 55 are mounted, the ring roller 52 is cooled to the normal temperature and to be shrunk. Accordingly, the planetary rollers 55 and the input shaft 57 squeeze together preload from the ring roller 52, thereby the traction grease 59 is quickly solidified into a glassy state at the contact part between the planetary rollers 55 and the input shaft 57. When the input shaft 57 is rotated in this state, in a counterclockwise direction of FIG. 3 by the transport motor 43, shearing resistance occurs due to the solidification of the traction grease 59 and each planetary roller 55 rotates in a clockwise direction.

Moreover, since the planetary rollers 55 and the ring roller 52 squeeze together, the traction grease 59 is also solidified at the contact part of the planetary rollers 55 and the ring roller 52. Therefore, when the planetary rollers 55 are rotated in a clockwise direction of FIG. 3, the ring roller 52 is also rotated in a clockwise direction. Since the output shaft 53 is also rotated in a clockwise direction, the rotation of the transport motor 43 is decelerately transmitted to the capstan roller 18. Thus, a gear or a timing belt is not used in the traction drive decelerating mechanism 42. Therefore, there occurs neither periodical vibration nor fluctuation of the rotational speed of the output shaft 53 when the rotation of the transport motor 43 is transmitted to the rotary shaft 41 of the capstan roller 18, which fact prevents the occurrence of uneven rotation of the capstan roller 18 due to the decelerating mechanism.

As shown in FIG. 2, in the present embodiment, the rotary shaft 41 of the capstan roller 18 and the output shaft 53 of the traction drive decelerating mechanism 42 are connected on the common axis in order to prevent the occurrence of uneven rotation of the capstan roller 18 due to the misplacement of the rotary shaft 41 and the output shaft 53. Concretely, a shaft insertion hole 64 is formed at the end on the transport motor 43 side of the rotary shaft 41 for fitting onto the output shaft 53, and the output shaft 53 is inserted in the shaft insertion hole 64. Thereby, the capstan roller 18 is controlled not to move to the directions other than its rotary shaft direction. The rotary shaft 41 is fixed to the output shaft 53 by a screw 65, so that the rotary shaft 41 and the output shaft 53 are integrately connected on the common axis.

Conventionally, since the end of the rotary shaft 41 at the transport motor 43 side is supported by the side plate 49 via a bearing, the rotary shaft 41 and the output shaft 53 are supported at three points. Even if the rotary shaft 41 and the output shaft 53 are integrated on the common axis, it is impossible to prevent the misplacement of the rotary shaft 41 and the output shaft 53 when there is a mounting error (assembling error) at the mounting position of the capstan roller 18 or the traction drive decelerating mechanism 42.

In the present embodiment, a cutout 63 is formed for penetrating the rotary shaft 41 into the side plate 49 so as that the end of the rotary shaft 41 on the transport motor 43 side will be supported by the traction drive decelerating mechanism 42 only. Thereby, one end of the rotary shaft 41 of the capstan roller 18 is supported by the traction drive decelerating mechanism 42 and the other end thereof is supported by the side plate 46 via the bearing 45. The capstan roller 18 is supported on the transport path of the recording sheet 11 at two points, the traction drive decelerating mechanism 42 and the side plate 46. The rotary shaft 41 and the output shaft 53 are cantilever-supported. Therefore, even if the mounting position of the capstan roller 18 or the traction drive decelerating mechanism 42 has an error, the rotary shaft 41 and the output shaft 53 do not go off axis, although they might incline to the transport path of the recording sheet 11.

When the capstan roller 18 inclines to the transport path of the recording sheet 11, the recording sheet 11 is likely to move obliquely. However, there is no influence in quality of the color print (not shown) if the oblique movement of the recording sheet 11 stays within the order of 100 μm. On the other hand, if the uneven rotation of the capstan roller 18 causes the transport amount of the recording sheet 11 to go uneven in the order of 10 μm, an uneven print density occurs on the color print. Therefore, the occurrence of the uneven print density can be prevented and the quality of the color print is unaffected when the rotary shaft 41 and the output shaft 53 are supported on two points and the oblique move of the recording sheet 11, if any, stays within the order of 100 μm.

The operation of the above embodiment is described now. When the print operation starts as shown in FIG. 1, the advancing roller 13 is rotated by the drive of the motor (not shown). Thereby, the recording sheet 11 is pulled out from the recording sheet roll 12.

When the recording sheet 11 pulled out from the recording sheet roll 12 is nipped by the transport roller pair 17, the capstan roller 18 of the transport roller pair 17 is rotated in a clockwise direction by the drive of the transport motor 43 (see FIG. 2). The recording sheet 11 is transported in the advancing direction. When the rear end of the recording area (not shown) of the recording sheet 11 passes over the thermal head 26, the thermal head 26 is moved to the pressing position, from the retreating position, to press the heat element array 26a on a margin (not shown) of the recoding sheet 11.

Next, the capstan roller 18 is rotated in a counterclockwise direction by the transport motor 43 to transport the recording sheet 11 in the printing direction. When the recording area of the recording sheet 11 reaches the heat element array 26a during the transport of the recording sheet 11, the heat element array 26a is heated based on the image data to color the yellow thermosensitive coloring layer of the recording sheet 11. Thereby, a yellow image is recorded line by line on the recording area of the recording sheet 11.

When printing of the yellow image is completed, the thermal head 26 is moved to the retreating position from the pressing position. Simultaneous with the transport of the recording sheet 11 in the advancing direction by the transport roller pair 17, the yellow fixing lamp 34 of the optical fixing device 28 is turned on. The yellow fixing lamp 34 is turned off when the recording area (not shown) of the recording sheet 11 passes over the optical fixing device 28. Thereby, the yellow image is fixed.

When fixing of the yellow image is completed, the recording sheet 11 is transported in the printing direction by the transport roller pair 17. A magenta image is printed in a manner similar to the yellow image during the transport of the recording sheet 11. The recording sheet 11 is again transported in the advancing direction by the transport roller pair 17 to fix the magenta image by the magenta fixing lamp 35. When fixing of the magenta image is completed, the recording sheet 11 is transported in the printing direction by the transport roller pair 17 to print a cyan image during the transport of the recording sheet 11 in a manner similar to the yellow and magenta images.

When printing of the cyan image is completed, the recording sheet 11 is transported in the advancing direction by the transport roller pair 17. The recording area of the recording sheet 11 is cut off by the cutter 29 and is discharged from the discharge slot 30 as a color print. Then, the front end of the recording sheet 11 is transported back to the position of the transport roller pair 17 for the standby to next print. If the following printing is not directed after a certain lapse of time, the recording sheet 11 is rewound on the recording sheet roll 12 and the printer 10 is turned off.

In the present embodiment, since the traction drive decelerating mechanism 42 is used as a decelerating mechanism which transmits rotation of the transport motor 43 to the capstan roller 18, there occurs neither periodical vibration nor fluctuation of rotational speed of the output shaft 53 connected to the rotary shaft 41 of the capstan roller 18. As a result, the occurrence of the uneven rotation of the capstan roller 18 due to the decelerating mechanism is prevented. Moreover, the rotary shaft 41 and the output shaft 53 are connected on the common axis and the capstan roller 18 is supported on two points of the traction drive decelerating mechanism 42 and the side plate 46, and the misplacement of the rotary shaft 41 and the output shaft 53 can thereby be prevented (see FIG. 2). As a result, the occurrence of the uneven rotation of the capstan roller 18 due to shaft misplacement is prevented, then the occurrence of uneven printing density on the color print can be prevented.

In the present embodiment, the end of the output shaft 53 of the traction drive decelerating mechanism 42 is inserted in the shaft insertion hole 64 of the rotary shaft 41 of the capstan roller 18 and fixed by the screw 65 to integrally connect the rotary shaft 41 and the output shaft 53 on the common axis, but the present invention is not limited to this. For example, although there is no drawings, figure is not shown, it may be possible to form a D-cut face at the end of the output shaft 53 and to form the shaft insertion hole 64 in the shape of “D” so that the rotary shaft 41 and the output shaft 53 are connected. In this case, the screw 65 is not necessary, so the number of the units can be reduced. Moreover, it may be possible to form the end of the output shaft 53 and the shaft insertion hole 64 in optional polygonal column shapes to connect the rotary shaft 41 and the output shaft 53.

Furthermore, in the present embodiment, printing direction is an opposite direction to the transport direction of the recording sheet 11 when the image is printed, but the present invention is not limited to this. When the transport roller pair 17 is disposed in the downstream side of the thermal head 26 in the advancing direction, printing direction may be a transport direction of the recording sheet 11 when the image is printed.

The present invention is applicable to a thermal printer which heats the ink ribbon from behind and transfers the ink to the recording sheet to print images. Moreover the present invention is applicable to an inkjet printer or a laser printer. Furthermore, the present invention is applicable to a color printer or monochrome printer.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A printer for printing an image on a recording material which is nipped and transported by a drive roller and a driven roller, said drive roller including a roller body and a rotary shaft, said rotary shaft having first and second ends extending from said roller body, said printer comprising:
a motor which rotates when said recording material is transported;
a traction drive decelerating mechanism for decelerating rotation of said motor, having an output shaft for outputting decelerated rotation;
a connector for connecting said output shaft of said traction drive decelerating mechanism and said first end of said drive roller on the common axis; and
a drive roller supporting mechanism for supporting said second end of said drive roller and said traction drive decelerating mechanism.

2. A printer as claimed in claim 1, wherein said drive roller supporting mechanism including:
a first bearing for enabling rotation of said second end; and
a second bearing for rotatably supporting said output shaft.

3. A printer as claimed in claim 2, wherein said drive roller supporting mechanism further including:
first and second side plates placed at both sides of said roller body, said first bearing being fit in said first side plate and an opening being formed on said second side plate for being penetrated by said first end; and
a supporting member fixed to said second side plate to cover said connector, said second bearing being fit in said supporting member, and said traction drive decelerating mechanism being fixed to said supporting member.

4. A printer as claimed in claim 3, wherein said traction drive decelerating mechanism including:
a ring roller formed integral with said output shaft;
an input shaft rotated by said motor, having a shaft end being placed at the center of said ring roller; and
a plurality of planetary rollers disposed about said input shaft inside said ring roller, for transmitting rotation of said input shaft to said ring roller.

5. A printer as claimed in claim 4, wherein said traction drive decelerating mechanism further including:
a case for housing said ring roller and said planetary rollers; and
grease filled in said case.

6. A printing method for printing an image on a recording material, comprising steps of:
rotating a motor;
transmitting rotation of said motor to a drive roller via a traction drive decelerating mechanism, a rotary shaft of said drive roller and an output shaft of said traction drive decelerating mechanism being connected on a common axis, said drive roller being rotatably supported at two points of one end of said rotary shaft of said drive roller and said traction drive decelerating mechanism;
nipping said recording material between said drive roller and said driven roller to transport said recording material; and
printing said image on said recording material during transport thereof line by line with a recording head.
